(19) United States
(12) Patent Application Publication
(10) Pub. No.: US 2007/0228188 A1
(43) Pub. Date: Oct. 4, 2007

(54) Liquid supplying device and liquid ejection apparatus

(75) Inventor: Tatsuya Seshimo, Nagano-Ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/729,127

(22) Filed: Mar. 27, 2007

(30) Foreign Application Priority Data
Mar. 27, 2006 (JP) P2006-085706

(51) Int. Cl. B05B 9/04; A62C 31/00

(52) U.S. Cl. 239/443; 239/373

(57) ABSTRACT

A valve unit incorporated in a printer supplies ink from an ink cartridge to a recording head. The valve unit forms a pressurizing chamber with a seal film arranged on the valve unit to temporarily store ink. A valve is arranged at an ink inlet of the pressurizing chamber. An actuation lever is arranged between the seal film and the valve in the pressurizing chamber. An electromagnet is arranged outside the pressurizing chamber at a position facing the actuation lever with the seal film located between the electromagnet and the actuation lever. The electromagnet moves the actuation lever with magnetic force without contacting the actuation lever in a manner that the actuation lever restricts movement of the seal film based on negative pressure that is generated when ink is discharged from the pressurizing chamber.

### CROSS-REFERENCE TO RELATED APPLICATIONS

This application is based upon and claims the benefit of priority from prior Japanese Patent Application No. 2006-085706, filed on Mar. 27, 2006, the entire contents of which are incorporated herein by reference.

### BACKGROUND

1. Technical Field

The present invention relates to a liquid supplying device and a liquid ejection apparatus.

2. Related Art

An inkjet printer (hereafter simply referred to as a “printer”) is widely known as a liquid ejection apparatus for ejecting liquid to a target. This printer has a recording head, which is a liquid ejection head, mounted on a carriage capable of reciprocation. Ink, which serves as a liquid, is supplied from an ink cartridge (liquid container) to the recording head. The ink cartridge is mounted at a predetermined position of the printer. The recording head ejects ink from nozzles formed on a nozzle formation surface of the recording head to a recording medium, which serves as a target, to perform printing.

JP-A-2005-186344 describes a printer including a valve unit serving as a liquid supplying device. The valve unit has a liquid supply passage for supplying ink from an ink cartridge to a recording head. A pressurizing chamber serving as a liquid storage unit for temporarily storing ink is formed in the liquid supply passage.

The pressurizing chamber of the valve unit is formed by a rigid passage formation body and a flexible film. The pressurizing chamber has a liquid inlet and a liquid outlet.

A valve for regulating the flow of ink from the ink inlet into the pressurizing chamber is arranged on the liquid supply passage. The ink in the pressurizing chamber decreases as the ink is ejected from the recording head and generates negative pressure in the pressurizing chamber so as to move the film and open the valve. This controls the pressure at which ink is supplied from the ink cartridge to the recording head.

In the printer, the valve functions as a choke valve for performing “choke cleaning”. The printer has a pin actuator for forcibly maintaining the valve in a closed position.

To perform choke cleaning, a suction pump performs a suction operation on the nozzle formation surface of the recording head while the valve is forcibly held in the closed position by the pin actuator. As a result, negative pressure is generated in the liquid passage at the recording head side of the valve. Afterwards, the valve opens and the negative pressure forces and ejects viscous ink and air bubbles from the nozzles.

The pin actuator used for choke cleaning includes a cylindrical member and a drive pin that slides within the cylindrical member. The drive pin moves between a choke position at which the drive pin lifts a movable pin incorporated in the valve unit and forcibly holds the valve at the closed position and a choke release position at which the drive pin releases the movable pin from the state forcibly holding the valve at the closed position.

The printer described in JP-A-2005-186344 is required to have the movable pin incorporated in the valve unit. This complicates the assembling processes of the valve unit. Further, when the drive pin is repeatedly moved, the drive pin and the cylindrical member may wear as the drive pin slides. This may deteriorate the durability of the pin actuator.

### SUMMARY

It is an object of the present invention to provide a liquid supplying device and a liquid ejection apparatus that are easy to assemble and have superior durability.

To achieve the above object, a first aspect of the present invention is a liquid supplying device including a passage formation body forming a liquid supply passage, a film member attached to the passage formation body, a valve, a movement member, and a magnetic force generation unit. The passage formation body and the film member form a liquid storage unit in the liquid supply passage for enabling temporary storage of a liquid. The film member is movable in accordance with pressure of the liquid storage unit. The passage formation body includes a liquid inlet and a liquid outlet that open in the liquid storage unit. The valve opens and closes the inlet. When liquid flows out of the outlet thereby generating negative pressure in the liquid storage unit and moving the film member, the movement of the film member is transmitted to the valve so that the valve opens the inlet. The movement member is arranged in the liquid storage unit so as to be located between the film member and the valve and is at least partially formed from a magnetic material. The magnetic force generation unit is arranged outside the liquid storage unit facing the movement member with the film member located between the magnetic force generation unit and the movement member. The magnetic force generation unit is capable of influencing the movement member with magnetic force so as to restrict movement of the film member based on the negative pressure generated in the liquid storage unit.

A second aspect of the present invention is a liquid ejection apparatus including a liquid container containing liquid, a liquid ejection head for ejecting the liquid, a liquid supply passage for supplying the liquid from the liquid container to the liquid ejection head, a passage formation body forming at least part of the liquid supply passage, a film member attached to the passage formation body, a valve, a movement member, and a magnetic force generation unit. The passage formation body and the film member form a liquid storage unit in the liquid supply passage for enabling temporary storage of a liquid. The film member is movable in accordance with pressure of the liquid storage unit. The passage formation body includes a liquid inlet and a liquid outlet that open in the liquid storage unit. The valve opens and closes the inlet. When liquid flows out of the outlet and into the liquid ejection head thereby generating negative pressure in the liquid storage unit and moving the film member, the movement of the film member is transmitted to the valve so that the valve opens the inlet. A movement member is arranged in the liquid storage unit so as to be located between the film member and the valve and is at least partially formed from a magnetic material. The magnetic force generation unit is arranged outside the liquid storage unit facing the movement member with the film member located between the magnetic force generation unit and the movement member. The magnetic force generation unit is capable of influencing the movement member with magnetic force so as to restrict movement of the film member based on the negative pressure generated in the liquid storage unit.

A third aspect of the present invention is a liquid ejection apparatus including a liquid container containing liquid, a liquid ejection head including a nozzle formation surface on which a nozzle for ejecting the liquid is formed, a liquid supply passage for supplying the liquid from the liquid container to the liquid ejection head, a passage formation body forming at least part of the liquid supply passage, a film member attached to the passage formation body, a valve, a movement member, an electromagnet, a cap, a suction device, and a control unit for controlling the electromagnet and the suction device. The passage formation body and the film member form a liquid storage unit in the liquid supply passage for enabling temporary storage of a liquid. The film member is movable in accordance with pressure of the liquid storage unit. The passage formation body includes a liquid inlet and a liquid outlet that open in the liquid storage unit. The valve opens and closes the inlet. When liquid flows out of the outlet and into the liquid ejection head thereby generating negative pressure in the liquid storage unit and moving the film member, the movement of the film member is transmitted to the valve so that the valve opens the inlet. The movement member is arranged in the liquid storage unit so as to be located between the film member and the valve and at least partially formed from a magnetic material. The electromagnet is arranged outside the liquid storage unit facing the movement member with the film member located between the electromagnet and the movement member. The electromagnet is capable of influencing the movement member with magnetic force so as to restrict movement of the film member based on the negative pressure generated in the liquid storage unit. The cap is capable of sealing the nozzle formation surface. The suction device is capable of performing suction inside the cap. The control unit controls the electromagnet and the suction device. When forcibly discharging liquid out of the liquid ejection head to perform cleaning, the control unit energizes the electromagnet to generate magnetic force with the electromagnet and operating the suction device to generate negative pressure in the liquid storage unit through the cap in a state in which the nozzle formation surface is sealed by the cap, stops energizing the electromagnet when the negative pressure generated in the liquid storage unit reaches a predetermined value corresponding to a predetermined opening timing of the valve, and re-energizes the electromagnet after flow speed of the liquid flowing in the liquid supply passage reaches a maximum flow speed.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic plan view showing an inkjet printer;

FIG. 2 is a cross-sectional view showing an ink cartridge in the printer of FIG. 1;

FIG. 3 is a schematic cross-sectional view of a cleaning mechanism in the printer of FIG. 1;

FIG. 4 is a partially exploded perspective view of a valve unit included in the printer of FIG. 1;

FIG. 5 is a cross-sectional view of the valve unit taken along line 5-5 of FIG. 4;

FIG. 6 is a cross-sectional view of a valve unit in which a movable valve is open;

FIG. 7 is a block circuit diagram showing the electrical structure of the printer of FIG. 1;

FIG. 8 is a flowchart showing a choke cleaning processing routine; and

FIG. 9 is a timing chart showing opening and closing timings of the movable valve.

### DESCRIPTION OF EXEMPLARY EMBODIMENTS

A liquid ejection apparatus of the present invention embodied in an inkjet printer 10 will now be described with reference to the drawings.

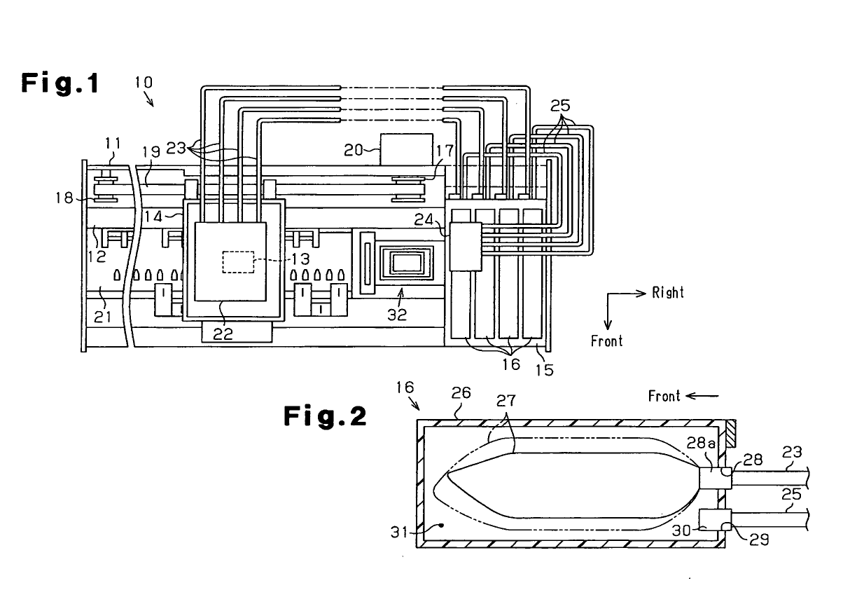

As shown in FIG. 1, the printer 10 serving as a liquid ejection apparatus includes a main body case 11, which is rectangular when viewed from above. A guide rod 12 is arranged in the main body case 11 to extend in the longitudinal direction of the main body case 11. A carriage 14 is supported on the guide rod 12 in a manner enabling reciprocation of the carriage 14 along the axis of the guide rod 12. A recording head 13 serving as a liquid ejection head is mounted on the carriage 14.

In the main body case 11, a cartridge holder 15 is arranged at a position outside the reciprocating range of the carriage 14 (at a right end position in FIG. 1) and ink cartridges 16 serving as a plurality of liquid containers are detachably set on the cartridge holder 15. In the present embodiment, four ink cartridges 16 are set on the cartridge holder 15. More specifically, the printer 10 of the present embodiment is not an on-carriage printer, in which ink cartridges are mounted on a carriage to move together with the carriage, and is an off-carriage printer, in which the ink cartridges 16 are separated from the carriage 14 and do not move together with the carriage 14.

A drive pulley 17 and a driven pulley 18 are rotatably supported on an inner surface of a rear side wall of the main body case 11 at positions corresponding to two ends of the guide rod 12.

An endless timing belt 19 connects the drive pulley 17 and the driven pulley 18. The drive pulley 17 is connected to an output shaft (not shown) of a carriage motor 20, which is fixed to an outer surface of the rear side wall of the main body case 11. Reciprocation of the carriage 14 in a main scanning direction (longitudinal direction of the main body case 11 in FIG. 1) along the guide rod 12 is enabled when drive force of the carriage motor 20 is transmitted to the carriage 14 by the timing belt 19.

A platen 21 is arranged under the guide rod 12 in the main body case 11. The platen 21 extends along the guide rod 12. The platen 21 functions as a support base for supporting paper serving as a target (not shown). A paper feed motor (not shown) is driven to feed a paper toward a front portion of the printer 10 (a lower portion in FIG. 1)

A valve unit 22 serving as a liquid supplying device for supplying ink serving as a liquid from the ink cartridge 16 to the recording head 13 is mounted on the carriage 14. The quantity of the ink cartridges 16 set on the cartridge holder 15 corresponds to the quantity of the colors of ink used in the printer 10, and the valve unit 22 is connected to the ink cartridges 16 via a plurality of ink supply tubes 23 respectively corresponding to the ink cartridges 16. In the present embodiment, four ink cartridges 16 corresponding to, for example, black, yellow, magenta, and cyan are set on the cartridge holder 15.

The valve unit 22 temporarily stores ink supplied from each ink cartridge 16 via the corresponding ink supply tube 23. Then, the valve unit 22 supplies the ink to the recording head 13 after adjusting the ink to a predetermined pressure. Each ink supply tube 23 forms a portion of a liquid supply passage for supplying ink from the ink cartridges 16 to the recording head 13. In the main body case 11, a pressurizing pump 24 is arranged above the cartridge holder 15. The pressurizing pump 24 is connected to the ink cartridges 16 by a plurality of (four in the present embodiment) air supply tubes 25.

As shown in FIGS. 1 and 2, each ink cartridge 16 has an ink case 26, which has the form of a rectangular box. The ink case 26 accommodates an ink pack 27 containing ink. An ink supply connection hole 28 extends through a rear wall of the ink case 26 at a generally middle portion of the rear wall of the ink case 26 in the vertical direction. An ink discharge tube 28a, which is tubular and formed integrally with the ink pack 27, is fitted in the ink supply connection hole 28 in a manner that one of its end is exposed from the ink case 26. An ink supply tube 23, which extends to the valve unit 22, is connected to the ink discharge tube 28a.

Further, an air supply connection hole 29 extends through the rear wall of the ink case 26 at a position below the ink supply connection hole 28. A connection tube 30, which is tubular, is fitted in the air supply connection hole 29 in a manner that one of its end is exposed outside the ink case 26 and the other one of its end is exposed in the ink case 26. The air supply tube 25, which extends from the pressurizing pump 24 as described above, has an end connected to a portion of the connection tube 30 exposed outside the ink case 26. A hermetically sealed air chamber 31 is formed in the ink case 26, specifically, between an inner surface of the ink case 26 and an outer surface of the ink pack 27.

When the pressurizing pump 24 is driven, pressurized air is sent into the air chamber 31 of the ink cartridge 16 via the air supply tube 25. The air pressure of the pressurized air squeezes the ink pack 27. The squeezing of the ink pack 27 supplies ink from the ink pack 27 to the valve unit 22 via the ink supply tube 23. Further, a home position region for the carriage 14 is defined in the main body case 11 near the right end of the main body case 11 as shown in FIG. 1. A cleaning mechanism 32 is arranged at the home position region.

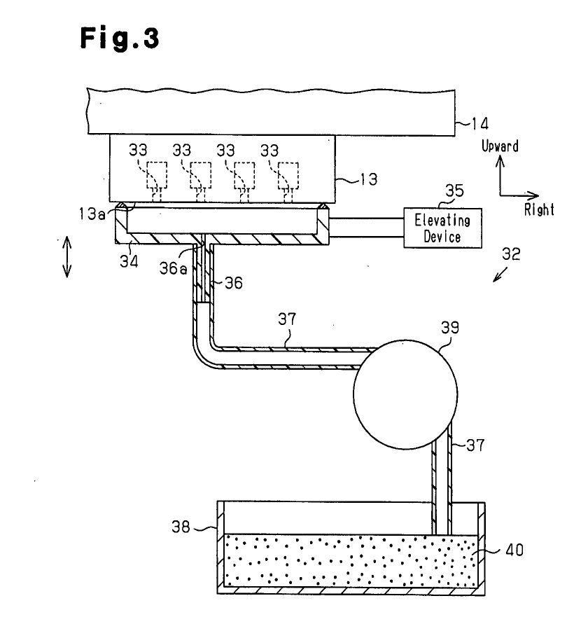

As shown in FIG. 3, the recording head 13 has a lower surface defining a nozzle formation surface 13a on which a plurality of nozzles 33 (four in the present embodiment) for ejecting ink are formed. The cleaning mechanism 32 includes a cap 34, which is a rectangular box having a closed bottom, and an elevating device 35 for raising and lowering the cap 34. The cleaning mechanism 32 seals the nozzle formation surface 13a of the recording head 13 with the cap 34 when the cap 34 is raised by the elevating device 35 in a state in which the carriage 14 is located at the home position region.

A projection 36 extends downward from a bottom wall of the cap 34. A discharge passage 36a extends vertically through the projection 36 to discharge ink out of the cap 34. A discharge tube 37, which is formed from a flexible material, has a basal end (upstream end) connected to the projection 36 and a distal end downstream end) inserted into a waste ink tank 38, which is in the form of a box. A suction pump 39 serving as a suction device for forcing the air in the cap 34 from the cap 34 toward the waste ink tank 38 is arranged in the discharge tube 37 between the cap 34 and the waste ink tank 38.

When the suction pump 39 is driven in a state in which the nozzle formation surface 13a of the recording head 13 is sealed by the cap 34, viscous ink and air bubbles are drawn out of the nozzles 33 and discharged into the waste ink tank 38 via the cap 34 and the discharge tube 37 to perform cleaning. The waste ink tank 38 accommodates a waste ink absorbent 40 for absorbing and retaining ink discharged into the waste ink tank 38.

The structure of the valve unit 22 will now be described in detail.

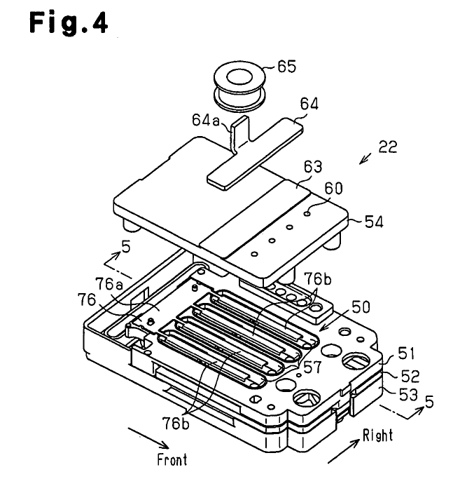

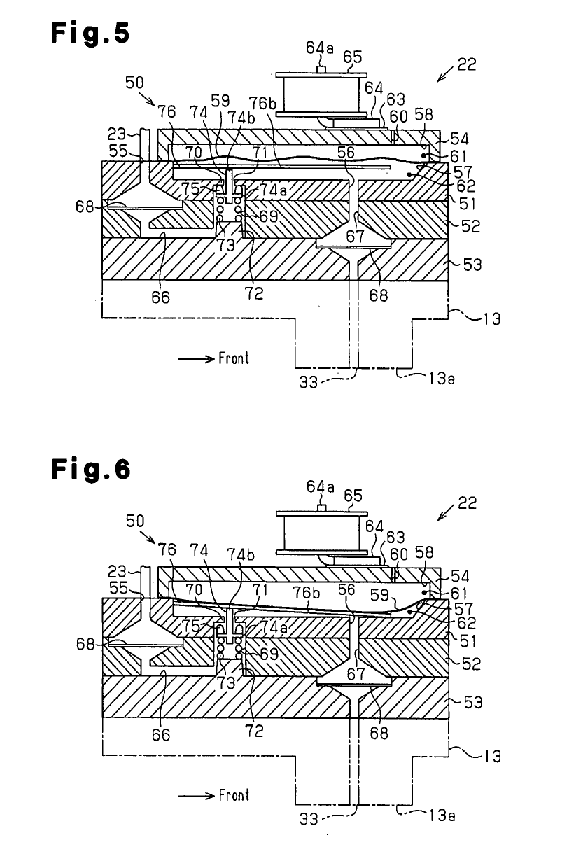

As shown in FIGS. 4 and 5, the valve unit 22 has a plurality of negative pressure generation devices 50 (four in the present embodiment) that are extended parallel to one another and arranged in a lateral direction inside the valve unit 22. Each negative pressure generation device 50 is supplied with ink from the corresponding ink cartridge 16.

The valve unit 22 is formed by stacking a pressurizing chamber component 51, a first flow passage component 52, a second flow passage component 53, and a protective plate 54, each of which has the form of a thin plate. The pressurizing chamber component 51, the first flow passage component 52, the second flow passage component 53, and the protective plate 54 each function as a rigid passage formation body. In detail, the pressurizing chamber component 51 is bonded to a lower surface of the protective plate 54, the first flow passage component 52 is bonded to a lower surface of the pressurizing chamber component 51, and the second flow passage component 53 is bonded to a lower surface of the first flow passage component 52. The recording head 13 is bonded to a lower surface of the second flow passage component 53.

A plurality of tube connection holes 55 to which the ink supply tubes 23 are connected, a plurality of generally rectangular groove passages 57 (four in the present embodiment) serving as openings, and a plurality of outlets 56 communicating the groove passages 57 with the recording head 13 are formed in an upper surface of the pressurizing chamber component 51. FIG. 5 shows the internal structure of the valve unit 22 as viewed in one of the four negative pressure generation devices 50. Thus, the valve unit 22 has the four locations at which the internal structure is identical to that shown in FIG. 5.

The protective plate 54 has a lower surface including groove recesses 58 arranged at positions facing the groove passages 57 of the pressurizing chamber component 51. The recesses 58 are covered by a single seal film 59 serving as a film member. The seal film 59 is thermally welded to the protective plate 54.

The protective plate 54 has a through-hole 60 having a small diameter connected to each recess 58. The space encompassed by the recess 58 and the seal film 59 when the protective plate 54 is bonded to the pressurizing chamber component 51 forms an atmospheric chamber 61 that is open to the atmosphere via the through-hole 60. The space encompassed by the groove passage 57 and the seal film 59 forms a pressurizing chamber 62 serving as a liquid storage unit. The pressurizing chamber 62 and the atmospheric chamber 61 are not in communication with each other.

A yoke plate 64, which is rectangular and extends in the lateral direction, is bonded to an upper surface of the protective plate 54 near the through-holes 60 by a bonding plate 63. A fitting member 64a, which is a generally rectangular plate extending upward, is arranged at a central portion of the yoke plate 64 with respect to the lateral direction. A cylindrical electromagnet 65 is fitted to the fitting member 64a. The electromagnet 65 functions as a magnetic force generation unit.

An inlet passage 66 connected to each tube connection hole 55 and an outlet passage 67 connecting each outlet 56 to the recording head 13 are arranged in the stacked structure formed by stacking the pressurizing chamber component 51, the first flow passage component 52, and the second flow passage component 53. A filter 68 is arranged in each of the inlet passage 66 and the outlet passage 67. A receptacle 69, which is in communication with each inlet passage 66, and a partition 70, which separates the receptacle 69 from the pressurizing chamber 62 (groove passage 57), are arranged in the stacked structure. A support hole 71, serving as an inlet connecting the receptacle 69 to the pressurizing chamber 62 (groove passage 57), is formed in each partition 70. The support hole 71 is located at a rear end side, or upstream side, of the pressurizing chamber 62.

A spring seat 72 is arranged in each receptacle 69. A movable valve 74 serving as a valve is arranged on the spring seat 72 by means of a seal spring 73, which is in the form of a coil. The movable valve 74 includes a plate member 74a and a rod member 74b that extends from an upper central portion of the plate member 74a and is inserted through the support hole 71. The rod member 74b has a top end extended through the support hole 71 and exposed in the pressurizing chamber 62. The seal spring 73 urges the movable valve 74 toward the partition 70.

An annular seal 75 is arranged on an upper surface of the plate member 74a so as to encompass the rod member 74b. When the seal 75 is pressed against the portion of the partition 70 around the support hole 71 by the urging force of the seal spring 73, the movable valve 74 is in a closed state. When the movable valve 74 is in the closed state, the receptacle 69 is disconnected from the pressurizing chamber 62.

An actuation lever 76 serving as a movement member and formed from a magnetic material is arranged in each pressurizing chamber 62. As shown in FIG. 4, the actuation lever 76 is formed from a single metal thin plate. The actuation lever 76 includes a support portion 76a supported between a lower surface of the protective plate 54 and an upper surface of the pressurizing chamber component 51 and four pressing portions 76b each formed by a thin plate extending along the corresponding pressurizing chamber 62 from the support portion 76a. Each pressing portion 76b is arranged in the corresponding pressurizing chamber 62 and is tilted slightly downward toward the front from the support portion 76a. Each pressing portion 76b has a distal end located at a position corresponding to the yoke plate 64. In other words, the seal film 59 is arranged between the actuation lever 76 and the electromagnet 65 and yoke plate 64.

Each pressing portion 76b has a rib on each of its two side edges to increase rigidity. In other words, each pressing portion 76b has a channel-like cross-section. A small gap is formed between a lower surface of the pressing portion 76b near the basal end and an upper end surface of the rod member 74b.

Each pressurizing chamber 62 stores ink supplied from the ink cartridge 16 via the corresponding ink supply tube 23. When ink is ejected from the nozzles 33 of the recording head 13, the ink in the pressurizing chamber 62 is drawn toward the recording head 13 and thereby decreases the pressure of the pressurizing chamber 62. As a result, the seal film 59 is resiliently deformed inward the pressurizing chamber 62 so as to downwardly press the pressing portion 76b of the actuation lever 76. Based on the principle of leverage, the pressing portion 76b downwardly presses the movable valve 74 with a force greater than the pressing force generated by the resilient deformation of the seal film 59. As a result, the movable valve 74 in the closed state is downwardly pressed against the urging force of the seal spring 73 so that the seal 75 of the movable valve 74 is spaced from the lower surface of the partition 70 as shown in the state of FIG. 6. As a result, ink is supplied into the pressurizing chamber 62 through the inlet passage 66 and the receptacle 69.

As the ink in the pressurizing chamber 62 increases and the pressure of the pressurizing chamber 62 increases, the seal film 59 moves outward from the pressurizing chamber 62. This eliminates the pressing force of the actuation lever 76 pressing the movable valve 74 so that the movable valve 74 is raised by the urging force of the seal spring 73. As a result, the seal 75 of the movable valve 74 is pressed against the lower surface of the partition 70 to stop the supply of ink from the inlet passage 66 to the pressurizing chamber 62.

The electrical structure of the printer 10 will now be described.

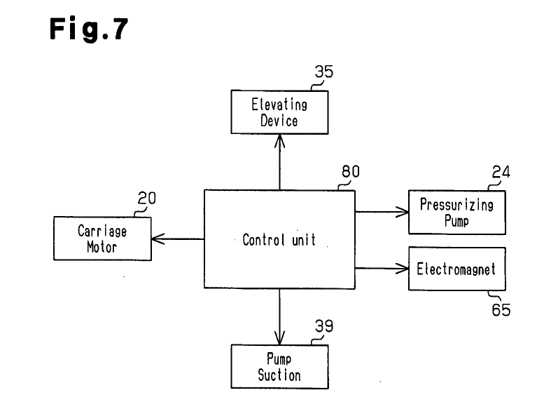

As shown in FIG. 7, the printer 10 includes a control unit 80. The control unit 80 is electrically connected to the carriage motor 20, the elevating device 35, the suction pump 39, the pressurizing pump 24, and the electromagnet 65. The control unit 80 controls the driving of the carriage motor 20, the elevating device 35, the suction pump 39, and the pressurizing pump 24. The control unit 80 also controls the energizing state of the electromagnet 65.

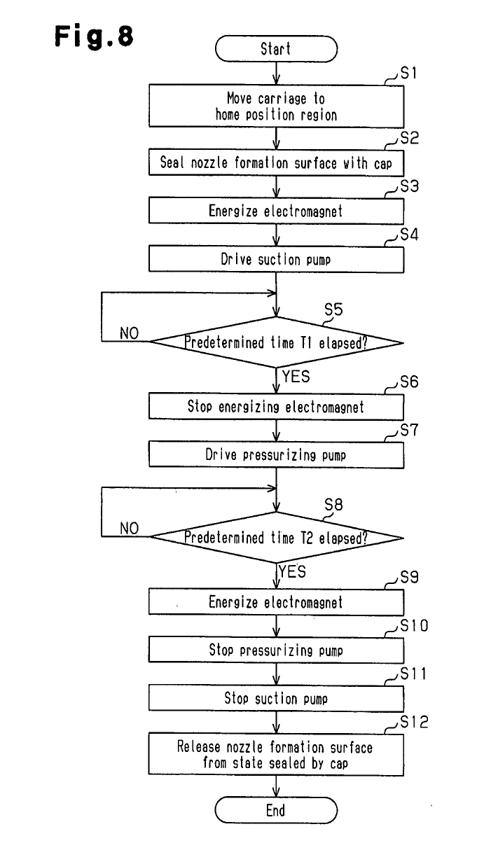

A choke cleaning processing routine executed by the control unit 80 will now be described with reference to the flowchart shown in FIG. 8.

The control unit 80 drives the carriage motor 20 and moves the carriage 14 to the home position region (step S1). The control unit 80 then drives the elevating device 35 and raises the cap 34 to seal the nozzle formation surface 13a of the recording head 13 (step S2). The control unit 80 then energizes the electromagnet 65 (step S3). As a result, the electromagnet 65 generates magnetic force so that the magnetic force upwardly attracts the distal portion of the pressing portion 76b. This maintains the pressing portion 76b in a horizontal state.

The control unit 80 next drives the suction pump 39 (step S4). As a result, the inner side of the cap 34 undergoes suction, and negative pressure is generated in the cap 34. When negative pressure is generated in the cap 34, negative pressure that causes the seal film 59 to move inward the pressurizing chamber 62 is generated in the pressurizing chamber 62. However, the pressing portion 76b is attracted by the magnetic force and maintained in the horizontal state. Thus, the rod member 74b is not pressed down by the seal film 59, and the movable valve 74 remains closed.

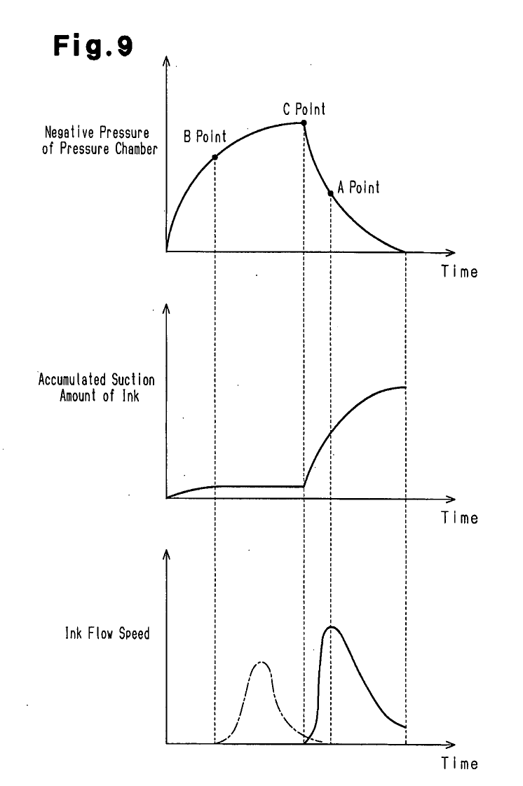

Then, the control unit 80 determines whether a predetermined time T1 has elapsed (step S5). In the present embodiment, the predetermined time T1 is the time from when the suction pump 39 is driven to when the negative pressure generated in the cap 34 reaches a maximum value (predetermined value). The control unit 80 prestores the predetermined time T1, which is obtained in advance through experiments etc., as the valve opening timing of the movable valve 74. More specifically, the predetermined time T1 is the time from when the suction pump 39 is driven to when the negative pressure generated in the cap 34 reaches the value of point C in the timing chart of FIG. 9.

When the determination in step S5 is a negative determination, the control unit 80 repeats the processing in step S5 until the determination in step S5 becomes an affirmative determination.

When the determination in step S5 is an affirmative determination, the control unit 80 stops energizing the electromagnet 65 (step S6) and drives the pressurizing pump 24 (step S7). As a result, the magnetic force of the electromagnet 65 is eliminated, and the force attracting the pressing portion 76b is eliminated. This elastically deforms the seal film 59 into the pressurizing chamber 62 and presses down the pressing portion 76b. As a result, the pressing portion 76b presses down the rod member 74b to open the movable valve 74.

When the movable valve 74 is open, the ink from the ink cartridge 16 flows into the pressurizing chamber 62 through the support hole 71 via the inlet passage 66, and the negative pressure accumulated in the pressurizing chamber 62 causes the ink in the pressurizing chamber 62 to be discharged suddenly into the cap 34 via the outlet passage 67 together with the viscous ink and air bubbles in the recording head 13. The control unit 80 then determines whether a predetermined time T2 has elapsed (step S8). The predetermined time T2 is the time from when the movable valve 74 opens to when the flow speed of ink in the outlet passage 67 reaches a value slightly less than a maximum value after exceeding the maximum value. The control unit 80 prestores the predetermined time T2 obtained in advance through experiments etc. More specifically, the predetermined time T2 is the time from when the movable valve 74 is open to when the negative pressure in the cap 34 reaches a value of point A in the timing chart of FIG. 9.

When the determination in step S8 is a negative determination, the control unit 80 repeats the processing in step S8 until the determination in step S8 becomes an affirmative determination. When the determination in step S8 is an affirmative determination, the control unit 80 again energizes the electromagnet 65 (step S9). As a result, the electromagnet 65 generates magnetic force so that the magnetic force attracts and upwardly moves the pressing portion 76b. As a result, the seal film 59 moves outward from the pressurizing chamber 62, and the urging force of the seal spring 73 lifts the movable valve 74.

The control unit 80 stops the pressurizing pump 24 (step S10) and stops the suction pump 39 (step S11). Then, the control unit 80 drives the elevating device 35 and lowers the cap 34 to release the nozzle formation surface 13a from the state sealed by the cap 34 (step S12). This ends the choke cleaning processing routine.

As described above, the control unit 80 executes the choke cleaning processing routine so that the negative pressure accumulated in the pressurizing chamber 62 is used to suddenly discharge the ink in the pressurizing chamber 62 into the cap 34 together with the viscous ink and air bubbles in the recording head 13.

The preferred embodiment has the advantages described below.

(1) The electromagnet 65 uses magnetic force to move each pressing portion 76b of the actuation lever 76 from the outer side of the pressurizing chamber 62 without contacting the pressing portion 76b. This prevents wear of the electromagnet 65 and the pressing portions 76b. As a result, the durability of the electromagnet 65 and the pressing portions 76b increases. This, in turn, increases the durability of the printer 10. Further, the electromagnet 65 is located outside the pressurizing chamber 62, or more specifically, on the upper surface of the protective plate 54. This facilitates the assembling of the valve unit 22.

(2) The magnetic force generated by the electromagnet 65 moves the pressing portions 76b. Thus, by energizing the electromagnet 65 at an appropriate timing, each pressing portion 76b moves only when necessary.

(3) The control unit 80 energizes the electromagnet 65 only when the magnetic force is necessary. This enables easy control of the generation of the magnetic force.

(4) To perform choke cleaning, the control unit 80 energizes the electromagnet 65 and drives the suction pump 39 to generate negative force in the pressurizing chamber 62. Further, the control unit 80 stops energizing the electromagnet 65 when the negative pressure in the pressurizing chamber 62 becomes maximum. Thus, the movable valve 74 opens when the negative pressure in the pressurizing chamber 62 becomes maximum so that viscous ink and air bubbles in the recording head 13 are suddenly discharged. In other words, the negative pressure is effectively used to perform choke cleaning of the recording head 13. As a result, the cleaning effect of choke cleaning is high.

In choke cleaning, the electromagnet 65 is re-energized when the flow speed of the ink flowing into the outlet passage 67 reaches a maximum flow speed after the movable valve 74 is open. In this case, the seal film 59 is forcibly pressed up by the pressing portion 76b although a negative pressure is generated in the pressurizing chamber 62. This ensures that the movable valve 74 is closed and stops the discharge of ink from the recording head 13.

After the flow speed of ink flowing within the outlet passage 67 becomes maximum, the flow speed of the ink gradually decreases. Thus, after the ink reaches the maximum flow speed, a cleaning effect that is the same or greater than when the flow speed of ink is maximum cannot be obtained even if ink were to be continuously discharged from the recording head 13. To prevent ink from being discharged from the recording head 13 in such a state in which cleaning is not efficiently performed, the electromagnet 65 is re-energized immediately after the flow speed of the ink flowing in the outlet passage 67 reaches the maximum flow speed. This prevents unnecessary ink from being discharged during choke cleaning and saves ink.

(5) Intermittent energizing of the electromagnet 65 oscillates the pressing portions 76b and discharges air bubbles from the pressurizing chamber 62.

The above embodiment may be modified in the following forms.

In step S5 of the choke cleaning processing routine, the predetermined time T1 may be set as a time from when the suction pump 39 is driven to when the negative pressure in the cap 34 reaches a value that is less than the maximum value. More specifically, the predetermined time T1 may be set as the time from when the suction pump 39 is driven to when the negative pressure in the cap 34 reaches a value of point B in the timing chart of FIG. 9. In this case, choke cleaning is performed with a small amount of ink being discharged from the recording head 13. The curve plotted along a broken line in the timing chart of FIG. 9 indicates the flow speed of ink flowing in the outlet passage 67 when the movable valve 74 is open at point B.

A permanent magnet may be used as a magnetic force generation unit instead of the electromagnet 65. In this case, a means for weakening a magnetic force of the permanent magnet to a level at which the magnetic force does not move the pressing portion 76b is necessary. For example, a unit for moving a member having high magnetic permeability (such as a steel plate) between a first position that is between the permanent magnet and the pressing portion 76b and a second position that is distant from the first position may be employed.

A portion (e.g. a distal portion) of the pressing portion 76b may be formed from a magnetic material, and the remaining portion of the pressing portion 76b may be formed from a nonmagnetic material.

Although the liquid ejection apparatus of the present invention is applied to a printer for ejecting ink (printing apparatuses including a facsimile and a copier) in the above embodiment, the present invention may be applied to other types of liquid ejection apparatuses for ejecting liquid. For example, the liquid ejection apparatus of the present invention may be an apparatus for manufacturing a liquid crystal display, a plasma display panel, an organic EL (electroluminescence) display, or an FED (field emission display). Such a liquid ejection apparatus ejects various materials including a color material or an electrode material for forming for example a pixel formation region or an electrode formation region. Further, the liquid ejection apparatus of the present invention may be a liquid ejection apparatus for ejecting liquid including living organisms for use in manufacturing a biochip.

What is claimed is:

1. A liquid supplying device comprising:
a passage formation body forming a liquid supply passage;
a film member attached to the passage formation body, wherein the passage formation body and the film member form a liquid storage unit in the liquid supply passage for enabling temporary storage of a liquid, the film member is movable in accordance with pressure of the liquid storage unit, and the passage formation body includes a liquid inlet and a liquid outlet that open in the liquid storage unit;
a valve for opening and closing the inlet, wherein when liquid flows out of the outlet thereby generating negative pressure in the liquid storage unit and moving the film member, the movement of the film member is transmitted to the valve so that the valve opens the inlet;
a movement member arranged in the liquid storage unit so as to be located between the film member and the valve, wherein the movement member is at least partially formed from a magnetic material; and
a magnetic force generation unit arranged outside the liquid storage unit and facing the movement member with the film member located between the magnetic force generation unit and the movement member, the magnetic force generation unit being capable of influencing the movement member with magnetic force so as to restrict movement of the film member based on the negative pressure generated in the liquid storage unit.

2. The liquid supplying device according to claim 1, wherein the magnetic force generation unit influences the movement member with magnetic force so as to attract the movement member in a direction opposite to the direction in which the film member moves based on the negative pressure generated in the liquid storage unit.

3. The liquid supplying device according to claim 1, wherein the magnetic force generation unit includes an electromagnet.

4. The liquid supplying device according to claim 3, further comprising:
a control unit for controlling an energizing state of the electromagnet.

5. The liquid supplying device according to claim 1, wherein the passage formation body includes a groove passage, and the groove passage has an opening formed in a surface of the passage formation body, and the liquid storage unit is formed by attaching the film member to the surface of the passage formation body so as to close the opening of the groove passage.

6. The liquid supplying device according to claim 1, wherein the movement member includes a basal end portion supported by the passage formation body and a distal portion facing toward the magnetic force generation unit, the movement member being capable of pressing the valve in a direction in which the valve opens at a portion between the basal end portion and the top end portion.

7. A liquid ejection apparatus comprising:
a liquid container containing liquid;
a liquid ejection head capable of ejecting the liquid;
a liquid supply passage for supplying the liquid from the liquid container to the liquid ejection head;
a passage formation body forming at least part of the liquid supply passage;
a film member attached to the passage formation body, wherein the passage formation body and the film member form a liquid storage unit in the liquid supply passage for enabling temporary storage of a liquid, the film member is movable in accordance with pressure of the liquid storage unit, and the passage formation body includes a liquid inlet and a liquid outlet that open in the liquid storage unit;
a valve for opening and closing the inlet, wherein when liquid flows out of the outlet and into the liquid ejection head thereby generating negative pressure in the liquid storage unit and moving the film member, the movement of the film member is transmitted to the valve so that the valve opens the inlet;
a movement member arranged in the liquid storage unit so as to be located between the film member and the valve, wherein the movement member is at least partially formed from a magnetic material; and
a magnetic force generation unit arranged outside the liquid storage unit and facing the movement member with the film member located between the magnetic force generation unit and the movement member, the magnetic force generation unit being capable of influencing the movement member with magnetic force so as to restrict movement of the film member based on the negative pressure generated in the liquid storage unit.

8. A liquid ejection apparatus comprising:
a liquid container containing liquid;
a liquid ejection head including a nozzle formation surface on which a nozzle for ejecting the liquid is formed;
a liquid supply passage for supplying the liquid from the liquid container to the liquid ejection head;
a passage formation body forming at least part of the liquid supply passage;
a film member attached to the passage formation body, wherein the passage formation body and the film member form a liquid storage unit in the liquid supply passage for enabling temporary storage of a liquid, the film member is movable in accordance with pressure of the liquid storage unit, and the passage formation body includes a liquid inlet and a liquid outlet that open in the liquid storage unit;
a valve for opening and closing the inlet, wherein when liquid flows out of the outlet and into the liquid ejection head thereby generating negative pressure in the liquid storage unit and moving the film member, the movement of the film member is transmitted to the valve so that the valve opens the inlet;
a movement member arranged in the liquid storage unit so as to be located between the film member and the valve, wherein the movement member is at least partially formed from a magnetic material;
an electromagnet arranged outside the liquid storage unit and facing the movement member with the film member located between the electromagnet and the movement member, the electromagnet being capable of influencing the movement member with magnetic force so as to restrict movement of the film member based on the negative pressure generated in the liquid storage unit;
a cap capable of sealing the nozzle formation surface;
a suction device capable of performing suction inside the cap; and
a control unit for controlling the electromagnet and the suction device, wherein when forcibly discharging liquid out of the liquid ejection head to perform cleaning, the control unit:
energizes the electromagnet to generate magnetic force with the electromagnet and operating the suction device to generate negative pressure in the liquid storage unit through the cap in a state in which the nozzle formation surface is sealed by the cap;
stops energizing the electromagnet when the negative pressure generated in the liquid storage unit reaches a predetermined value corresponding to a predetermined opening timing of the valve; and
re-energizes the electromagnet after flow speed of the liquid flowing in the liquid supply passage reaches a maximum flow speed.
